(19) United States
(12) Patent Application Publication
(10) Pub. No.: US 2004/0150740 A1
(43) Pub. Date: Aug. 5, 2004

(54) Miniaturized image sensor module

(76) Inventor: Chung Hsien Hsin, Hsinchu Hsien (TW)

Correspondence Address: PRO-TECHTOR INTERNATIONAL, 20775 Norada Court, Saratoga, CA, 95070-3018, US

(21) Appl. No.: 10/356,184

(22) Filed: Jan. 30, 2003

(51) Int. Cl. H04N 5/225

(52) U.S. Cl. 348/340

(57) ABSTRACT

A miniaturized image sensor module of the invention includes a printed circuit board, an image sensor, a lens holder and a lens barrel. The circuit board has an upper surface, a lower surface and a slot. The image sensor has a first face and a second face, wherein the first face is formed with signal output terminals electrically connected to the lower surface of the circuit board so that the image sensor is positioned below the slot. The lens holder has a top face, a bottom face and a hole penetrating through the lens holder. The bottom face is fixed to the upper surface of the circuit board and is positioned above the slot. The lens barrel is contained in the hole and is formed with a chamber so that the image sensor may receive optical signals passing through the chamber, and transfer signals to the circuit board.

### BACKGROUND OF THE INVENTION

1. Field of the Invention

The invention relates to a miniaturized image sensor module.

2. Description of the Related Art

Referring to FIG. 1, a conventional image sensor module includes a lens holder 10, a lens barrel 20, and an image sensor 30. The lens holder 10 has a top face 12, a bottom face 14 and a hole 16 penetrating through the lens holder 10 from the top face 12 to the bottom face 14. The hole 16 of the lens holder 10 is formed with an internal thread 18. The lens barrel 20 is formed with an external thread 22, inserted into the hole 16 from the top face 12 of the lens holder 10, and screwed to the internal thread 18 of the lens holder 10. The lens barrel 20 is formed with a chamber 24, in which an aspheric lens 26 and an infrared filter 28 are positioned. The image sensor 30 has a first face 32 and a second face 34. The first face 32 is formed with a transparent layer 36, and the second face 34 is mounted to a printed circuit board 31. In addition, the bottom face 14 of the lens holder 10 is fixed to the printed circuit board 31 and the image sensor 30 is contained in the hole 16 of the lens holder 10. It is possible to adjust the screwed length between the lens barrel 20 and the lens holder 10 in order to control the distance from the aspheric lens 26 of the lens barrel 20 to the transparent layer 36 of the image sensor 30.

According to the above-mentioned structure, the overall volume of the module is larger, and the image sensor module cannot be miniaturized.

### SUMMARY OF THE INVENTION

An object of the invention is to provide an image sensor module, which has a miniaturized volume and is more practical.

To achieve the above-mentioned object, the invention provides a miniaturized image sensor module including a printed circuit board, an image sensor, a lens holder and a lens barrel. The printed circuit board has an upper surface, a lower surface and a slot penetrating through the circuit board from the upper surface to the lower surface. The image sensor has a first face and a second face, wherein the first face is formed with signal output terminals electrically connected to the lower surface of the printed circuit board so that the image sensor is positioned below the slot. The lens holder has a top face, a bottom face and a hole penetrating through the lens holder from the top face to the bottom face. The bottom face is fixed to the upper surface of the printed circuit board and is positioned above the slot. The lens barrel is inserted into the hole from the top face of the lens holder and is formed with a chamber so that the image sensor may receive optical signals passing through the chamber, and then transfer signals to the printed circuit board.

### BRIEF DESCRIPTION OF THE DRAWINGS

FIG. 1 is a schematic illustration showing a conventional image sensor module.

FIG. 2 is an exploded, cross-sectional view showing an image sensor module of the invention.

FIG. 3 is a cross-sectional view showing the image sensor module of the invention.

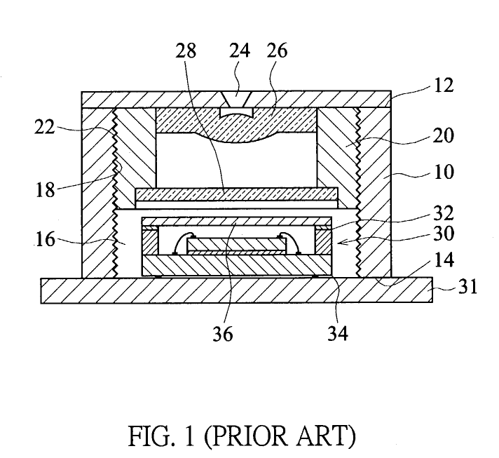

### DETAILED DESCRIPTION OF THE INVENTION

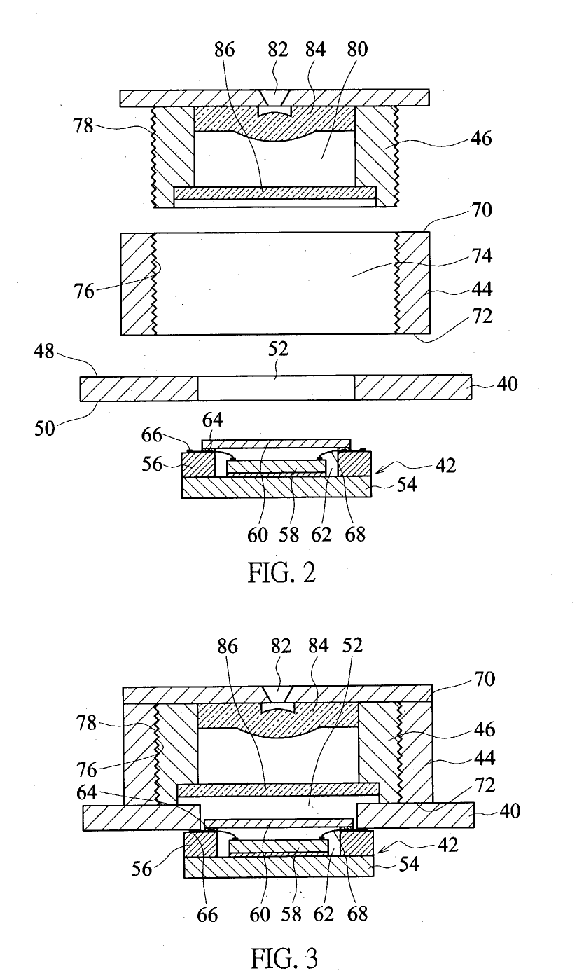

Referring to FIG. 2, an image sensor module of the invention includes a printed circuit board 40, an image sensor 42, a lens holder 44 and a lens barrel 46.

The printed circuit board 40 has an upper surface 48, a lower surface 50 and a slot 52 penetrating through the printed circuit board 40 from the upper surface 48 to the lower surface 50.

In this embodiment, the image sensor 42 includes a substrate 54, a frame layer 56, a photosensitive chip 58 and a transparent layer 60. The frame layer 56 is arranged on the substrate 54 to form a cavity 62 together with the substrate 54. A plurality of signal input terminals 64 and a plurality of signal output terminals 66 are formed on a top of the frame layer 56 and electrically connected to the lower surface 50 of the printed circuit board 40, wherein the signal input terminals 64 are positioned below the slot 52. The photosensitive chip 58 is contained in the cavity 62 and is electrically connected to the signal input terminals 64 of the frame layer 56 through a plurality of wires 68. The transparent layer 60 is placed on the frame layer 56, and then the photosensitive chip 58 may receive optical signals passing through the transparent layer 60 and the slot 52.

The lens holder 44 has a top face 70, a bottom face 72 and a hole 74 penetrating through the lens holder 44 from the top face 70 to the bottom face 72. The bottom face 72 of the lens holder 44 is fixed to the upper surface 48 of the printed circuit board 40 and the lens holder 44 is positioned above the slot 52. In addition, the hole 74 is also formed with an internal thread 76.

The lens barrel 46 is formed with an external thread 78 and is screwed to the internal thread 76 of the lens holder 44 so that the lens barrel 46 is contained in the hole 74 of the lens holder 44. The lens barrel 46 is also formed with a chamber 80 and an opening 82 communicating with the chamber 80. In addition, an aspheric lens 84 and an infrared filter 86 are also contained in the chamber 80 of the lens barrel 46 so that the image sensor 42 may receive optical signals passing through the slot 52 and the chamber 80 of the lens barrel 46, and then transfer signals to the printed circuit board 40.

During the assembling process, as shown in FIG. 3, a packaged image sensor 42 is fixed to the lower surface 50 of the printed circuit board 40. Then, the signal output terminals 66 of the image sensor 42 are electrically connected to the printed circuit board 40 so that the image sensor 42 is positioned below the slot 52 of the printed circuit board 40.

Furthermore, the bottom face 72 of the lens holder 44 is fixed to the upper surface 48 of the printed circuit board 40 so that the lens holder 44 is positioned above the slot 52. Finally, the lens barrel 46 is screwed to the chamber 80 of the lens holder 44. Therefore, it is possible to adjust the focal length of the image sensor 42 by adjusting the screwed depth.

Since the distance between the opening 82 and the photosensitive chip 58 is a specific value, the thickness of the printed circuit board 40 may be reduced. So, the image sensor module may be miniaturized.

While the invention has been described by way of an example and in terms of a preferred embodiment, it is to be understood that the invention is not limited to the disclosed embodiment. To the contrary, it is intended to cover various modifications. Therefore, the scope of the appended claims should be accorded the broadest interpretation so as to encompass all such modifications.

What is claimed is:

1. An image sensor module, comprising:
a printed circuit board having an upper surface, a lower surface and a slot penetrating through the printed circuit board from the upper surface to the lower surface;
an image sensor on which a plurality of signal output terminals and a plurality of signal input terminals are formed, the plurality of signal output terminals being electrically connected to the lower surface of the printed circuit board so that the image sensor is positioned below the slot;
a lens holder having a top face, a bottom face and a hole penetrating through the lens holder from the top face to the bottom face, the bottom face being fixed to the upper surface of the printed circuit board and positioned above the slot; and
a lens barrel inserted into the hole from the top face of the lens holder, the lens barrel being formed with a chamber so that the image sensor may receive optical signals passing through the slot and the chamber of the lens barrel, and then transfer signals to the printed circuit board.

2. The image sensor module according to claim 1, wherein the image sensor comprises:
a substrate;
a frame layer, on which signal input terminals and signal output terminals are formed, arranged on the substrate;
a photosensitive chip arranged on the substrate;
a plurality of wires for electrically connecting the photosensitive chip to signal input terminals of the frame layer; and
a transparent layer arranged on a top of the frame layer.

3. The image sensor module according to claim 1, wherein the hole of the lens holder is formed with an internal thread, and the lens barrel is formed with an external thread screwed to the hole of the lens holder.

4. The image sensor module according to claim 1, wherein the lens barrel is formed with an opening communicating with the chamber of the lens barrel, an aspheric lens is arranged in the chamber and below the opening, and an infrared filter is arranged in the chamber and below the aspheric lens.
